(19) United States
(12) Patent Application Publication
(10) Pub. No.: US 2007/0032268 A1
(43) Pub. Date: Feb. 8, 2007

(54) Communications device and card

(76) Inventor: Bradley L. Gotfried, Sai kung (HK)

Correspondence Address: AKERMAN SENTERFITT, P.O. BOX 3188, WEST PALM BEACH, FL, 33402-3188, US

(21) Appl. No.: 11/195,171

(22) Filed: Aug. 2, 2005

(51) Int. Cl. H04K 1/00; H04L 9/00; H04B 1/38; H04M 1/00; G06F 17/60

(52) U.S. Cl. 455/558; 455/566; 455/550.1

(57) ABSTRACT

A communications device includes a transceiver for sending and receiving wireless signals, a screen for displaying one or more text and graphics, one or more input structures for inputting information, and a removable smart card having one or more card engines and one or more data stores, the data stores storing data related to one or more geographic areas and one or more assigned values. The present invention also provides a smart card including one or more card engines where the card engine determines operability of the smart card based on an assigned value. The smart card also includes one or more data stores where the data store stores geographic region data and one or more assigned values. The data can include one or more of regional telephone numbers, regional addresses, regional advertisements, regional historic information, regional custom information, regional directions, and regional tourist information.

### FIELD OF THE INVENTION

The present invention relates to communication devices and methods, and more particularly, to mobile communication devices and methods for assisting travelers.

### BACKGROUND OF THE INVENTION

With the establishment of vast transportation networks, the world has become an interconnected society. Today, it is common for people to travel from one country to another while conducting business or simply on vacation. Such travelers need to be able to communicate with a variety of distant people ranging from their family and friends to people associated with their business. Thus, many travelers carry mobile communication devices, such as cellular phones, satellite phones, two-way radios, and text messaging devices to communicate with the distant people.

Many cellular phone networks that are present in different countries operate on uniform standards and allow a non-native mobile device user to utilize a native wireless network. Nevertheless, the non-native mobile device user is typically charged an exorbitant rate just to access and use the wireless network. Additionally, while some wireless networks attempt to provide instructions to non-native users in the form of a text message, the text message can be provided in the language of the local region. Thus, a traveler may not be able to read instructions provided, and therefore, may not know at what rate they are being charged.

Furthermore, travelers typically reside in towns and cities with which they are not familiar. For instance, a traveler may not know the location of basic places, such a hospital, a police station, and a train station. Nevertheless, the traveler may need to know the location of such places many times throughout a typical day of travel. Further, due to some travelers' lack of experience in different nations, some travelers may not appreciate local customs and habits. To exacerbate this problem, many travelers can not effectively communicate with the local population. Additionally, most travelers do not have an appreciation and/or understanding of the value of the currencies of different nations. With the volatile fluctuation in exchange rates of some nations, even a traveler whom generally understands the different currencies can not know current exchange rates on a daily basis. Such a general lack of familiarity with particular nations and/or regions can tarnish a traveler's experiences, or complicate mundane tasks, such as using a pay phone and asking for directions.

### SUMMARY OF THE INVENTION

The present invention provides communications device and method for assisting travelers. The communications device includes a transceiver for sending and receiving wireless signals, a screen for displaying one or more text and graphics, one or more input structures for inputting information, and a removable smart card having one or more card engines and one or more data stores, the data stores storing data related to one or more geographic areas and one or more assigned values. The card engine determines operability of the communications device based on one or more assigned values. The data stored in the data store can include one or more of regional telephone numbers, regional addresses, regional advertisements, regional historic information, regional custom information, regional directions, and regional tourist information.

In one embodiment, the card engine can be configured to signal the screen to display one or more of the data related to one or more geographic regions and the assigned value. The card engine can further be configured to update the assigned value according to signals received by the transceiver.

In another embodiment, the card engine can be configured to translate regional language into the native language of a user. Additionally, the card engine can be configured to translate the native language of a user into the regional language.

In still another embodiment, the card engine can be configured to convert regional currency values into the native currency values of a user. Additionally, the card engine can be configured to convert the native currency values of a user into the regional currency values.

The present invention also provides a smart card including one or more card engines where the card engine determines operability of the smart card based on an assigned value. The smart card also includes one or more data stores where the data store stores geographic region data and one or more assigned values. The geographic region data can include one or more of regional telephone numbers, regional addresses, regional advertisements, regional historic information, regional custom information, regional directions, and regional tourist information.

In one embodiment, the card engine can be configured to signal the screen to display the geographic region data. Additionally, the card engine can be configured to update the one or more assigned values according to received signals.

In another embodiment, the card engine can be configured to translate regional language into the native language of a user. Additionally, the card engine can be configured to translate the native language of a user into the regional language.

In still another embodiment, the card engine can be configured to convert regional currency values into the native currency values of a user. Additionally, the card engine can be configured to convert the native currency values of a user into the regional currency values.

Also in accordance with the inventive arrangements a travel assistance device is provided. The device includes a machine readable storage having disposed thereon a currency converter and a text translator. The machine readable storage further includes a computer program having a routine set of instructions for limiting access to a wireless network based upon an access value pre-stored with the machine readable storage. The machine readable storage can have a plurality of code sections executable by a machine for causing the machine to perform the step of signaling the device to display one or more of data related to one or more geographic regions and the access value.

In one arrangement, the machine readable storage includes a plurality of code sections executable by a machine for causing the machine to perform the steps of translating regional language into the native language of a user and translating the native language of a user into the regional language. Additionally, the machine readable storage includes a plurality of code sections executable by a machine for causing the machine to perform the steps of converting regional currency values into the native currency values of a user and converting the native currency values of a user into the regional currency values. The machine readable storage can have a plurality of code sections executable by a machine for causing the machine to perform the step of updating the access value according to signals received by the device.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic drawing showing a smart card being inserted into a communications device in accordance with the inventive arrangements.

FIG. 2A is a schematic drawing of a smart card in accordance with the inventive arrangements.

FIG. 2B is a schematic drawing showing another embodiment of a communications device in accordance with the inventive arrangements.

FIG. 3 is a flow diagram of one embodiment of the present invention.

### DETAILED DESCRIPTION OF THE PREFERRED EMBODIMENTS

The present invention generally provides a system and method for operating a communications device in any geographic region. More particularly, the invention provides a system and method for gaining access to wireless communication networks in any geographic region while providing the user with geographic specific information. The present invention also provides a smart card for use in combination with a communications device that can be used to determine the operability of the communications device.

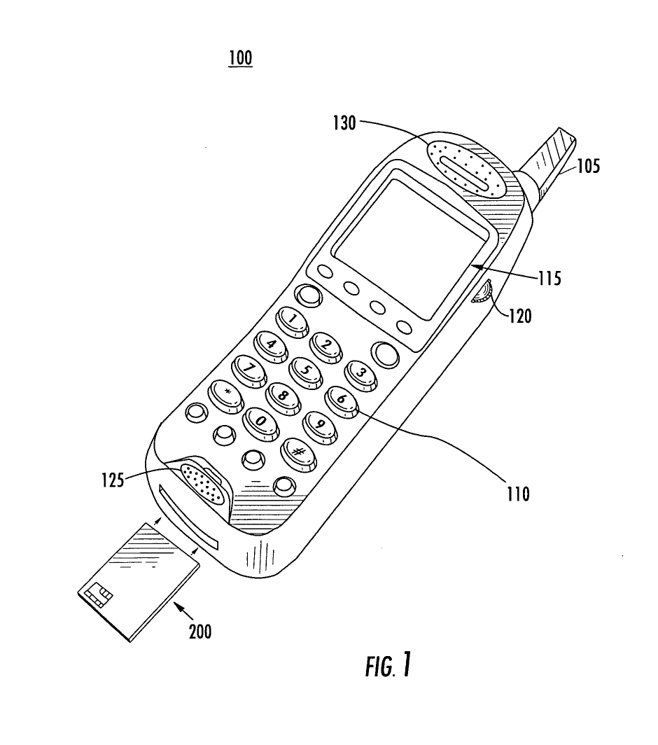

Referring to FIG. 1, a communications device 100 is provided in accordance with the inventive arrangements. The communications device 100 includes a transceiver 105, at least one input structure 110, a screen 115, and a removable smart card 200. The communications device 100 can also include a microphone 125 and a speaker 130 for use in oral communication. The communications device 100 can communicate wirelessly with a mobile communications network and is not limited to any particular communications device. For example, the communications device 100 can include a cellular phone, a personal digital assistant, a tablet personal computer, and the like.

The transceiver 105 can be any suitable structure for sending and receiving wireless signals. The transceiver 105 can be configured to send and receive wireless transmissions over any wireless standard, such as second-generation and third-generation code-division multiple access (CDMA) generally used in ultra-high-frequency (UHF) cellular telephone systems in the 800-MHz and 1.9-GHz bands. Other suitable wireless standards include time division multiple access (TDMA) used by Digital-American Mobile Phone Service (D-AMPS), Global System for Mobile communications (GSM), Personal Digital Cellular (PDC), and the Personal Communications Service (PCS). One skilled in the art would-appreciate that the transceiver 105 can also be configured to operate with evolving standards such as High-Speed Circuit-Switched Data (HCSD), General Packet Radio System (GPRS), Enhanced Data GSM Environment (EDGE), and Universal Mobile Telecommunications Service (UMTS). The transceiver 105 can also be configured for use with any suitable wireless network connection over the Bluetooth standard, the 802.11 family of wireless protocols, infrared and the like.

The input structure 110 can be used to input information to the communications device 100. As shown in FIG. 1, one embodiment of an input structure 110 is shown as a standard keypad for inputting numbers, text, and/or symbols. In such an embodiment, each separate key on the keypad can be depressed in a particular combination to input a variety of numbers, text, and/or symbols. Further, the keypad can be configured to input specific information when various keys are depressed in a particular order. Although FIG. 1 illustrates the input structure 110 as a standard telephone keypad, the invention is not limited in this regard. For instance, the input structure can be any suitable structure for inputting information, such as a QWERTY keypad, navigation buttons, a track pad, a roller, and the like. Information can also be input wirelessly with another device using infrared, short range radio frequency transmissions, and/or Bluetooth.

The communications device 100 can also include a complimentary input structure 120 to be used separately or in conjunction with the input structure 110. The complimentary input structure 120 is shown as a scroll wheel that can be used to navigate menus presented by the communications device 100. As is known in the arts, the scroll wheel can be rotated to navigate through menus and can also be depressed to indicate a selection.

The communications device 100 also includes a screen 115 for displaying text and/or graphics for viewing by the user. For instance, the screen 115 can display the information that is entered using the input structure 110. The screen 115 can also display communication device 100 diagnostic information and information from the smart card 200, as will be discussed later. The screen 115 can be any suitable screen for displaying text and/or graphics such as a liquid crystal display, a plasma screen, and cathode tube ray technology. With a liquid crystal display, it should be noted that active matrix technology can be used to increase viewability, particularly with mobile communication devices 100 used in direct sunlight. It should also be noted that the screen 115 can include touch screen technology for inputting information, and therefore, the input structure 110 and the screen 115 can be combined.

The removable smart card 200 is shown separate from the communications device 100 and arrows are used to indicate that the smart card 200 can be inserted into the communications device 100. Once inserted, the smart card 200 can communicate with the communications device 100. Alternatively, the smart card 200 can be placed proximate to the communications device 100 and the smart card 200 and the communications device 100 can communication wirelessly.

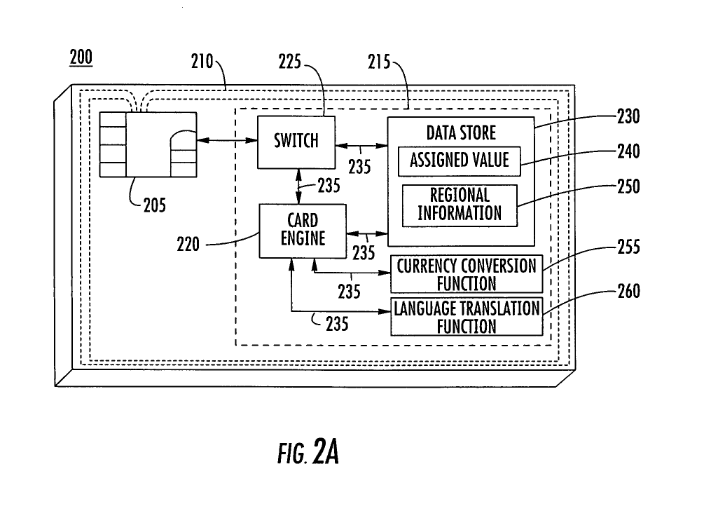

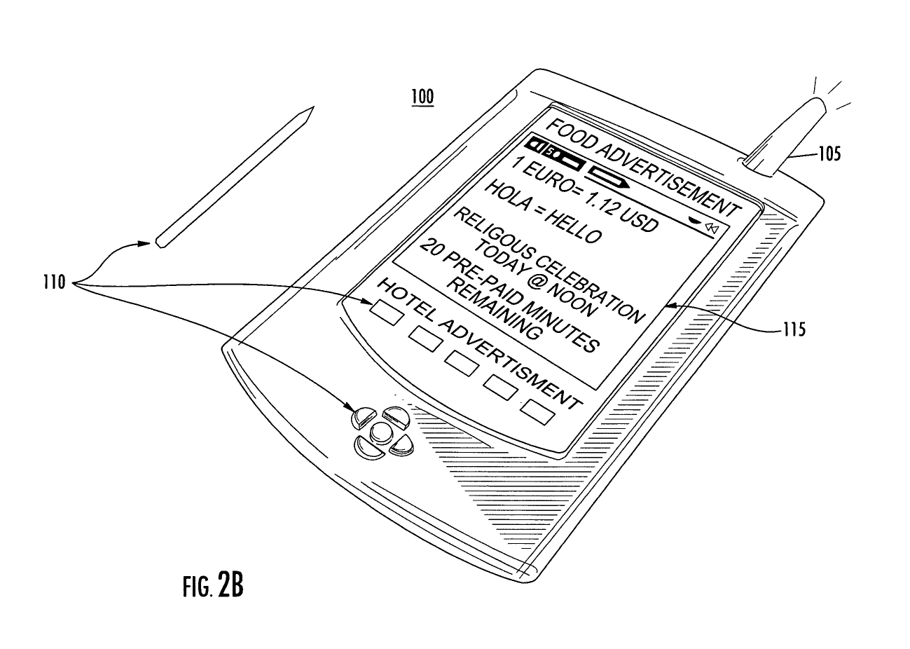

In FIG. 2, a schematic of a smart card is shown. The smart card 200 can include contacts 205, a wireless transceiver 210 (shown in phantom), and circuit 215 shown with dotted lines to indicate its location enclosed by the surface of the card. The smart card 200 can conform to a variety of standards, such as the ISO 7816 standard, proprietary standards, the PC/SC specification, and others.

The contacts 205 can be used to transmit data from the communication device 100 to the smart card 200. The contacts 205 can be constructed of any suitable material such as a metal material and can include any suitable structure and arrangement for data transmission. In one instance, the contacts can conform to ISO 7816-2 standard that define the location, purpose and electrical characteristics of the contacts. The contacts can include contacts for a power supply voltage, a reset, a clock, a ground, a programming voltage, and an input/output. Nevertheless, the invention is not limited to any particular standard as any appropriate structure and arrangement of the contacts 205 is suitable.

The wireless transceiver 210 is shown in phantom in FIG. 2 indicating that the wireless transceiver 210 is deposed within the surfaces of smart card 200. The wireless transceiver 210 can send and receive transmissions over any suitable radio frequency. The wireless transceiver 210 can allow wireless communication with proximate communication devices and/or other card readers. The wireless transceiver 210 can allow a smart card 200 to communicate with a communications device 100 without the need for inserting the smart card 200 into the communications device 100.

The circuit 215 of the smart card 200 can also be enclosed within the surfaces of the smart card 200, as indicated by the dotted lines. The circuit 215 can include a card engine 220, a switch 225, and a data store 230. The card engine 220, the switch 225, and the data store 230 can be communicatively linked via buses 235. The switch 225 can channel incoming data from any of multiple input ports to the specific output port that will take the data toward its intended destination and can be communicatively linked to the contacts 205 via bus 245.

The data store 230 of smart card 200 can include any suitable storage medium. A non-exhaustive list of examples of suitable storage mediums include random access memory (RAM), read only memory (ROM), flash memory, and the like. The data store 230 is also not limited to a type of storage medium as the data store 230 can include combinations of multiple memory formats and structures.

The card engine 220 can include a processor and can be referred to as a central processing unit and/or a microprocessor. The card engine 220 can be arranged with suitable logical circuitry programmed with suitable software, firmware, and a card operating system (COS). The COS can include any appropriate COS such as an ISO 7816-4 compliant COS and a Global Platform compliant COS using Java. The card engine 220 provides on-card dynamic data processing capabilities and multifunction capabilities by allocating the data store 230 into independent sections assigned to a specific function and/or application. The card engine 220 manages the data store 230 allocation and controls file access. Such access control permits different and multiple functions and/or different applications to be stored in the data store 230. The dynamic processing allows the information in the data store 230 to be updated when appropriate.

The card engine 220 controls access to and the storage of data in the in data storage 230. The content of the data stored in the data store 230 can include information related to one or more geographic regions 250 and one or more assigned values 240. The assigned values 240 can be any value, symbol, and/or number that can be accessed by the card engine 220 for determining the operability of the smart card 200 and the communications device 100. For instance, the assigned values 240 can correspond to prepaid minutes of connection time to a wireless network. Additionally, the assigned values 240 can include other information, such as user age, clearance status, and access level, for determining operability of the smart card 200 and the communications device 100. Thus, the assigned values can indicate complete operability and can also indicate partial operability of particular functions while restricting the operation of other functions.

Further, the information related to one or more geographic regions 250 can include regional telephone numbers, regional addresses, regional advertisements, regional historic information, regional custom information, regional directions, and regional tourist information. As used herein, “regional” can refer to areas defined by geographic landscape, social areas, economic areas, religious areas, national borders, and the like. For instance, the regional custom information can include customs regarding a particular geographic region that spans multiple nations; however, regional custom information can also include only one nation within a larger geographic region.

In operation, a user can insert the smart card 200 into a communications device 100 to allow communication via the contacts 205. Alternatively, it should be noted that a smart card 200 with a wireless transceiver 210 can be placed proximate to the communications device 100 to allow wireless communication. In either arrangement, the card engine 220 can query the data store 230 for the assigned value 240 to determine operability of the communications device 100. Once the card engine 220 determines that the operability of the communications device 100 is appropriate, the card engine 220 signals the communications device 100 to enable functionality of the communications device 100. In the enabled state, the user can use the wireless communications device 100 for the available functions, such as a wireless phone, sending and receiving email, text message, pages, and the like.

FIG. 2B depicts one embodiment of a communications device 100 in operation with the screen 115 displaying multiple information. In FIG. 2B, the smart card 200 has been inserted in the communications device 100 and is not shown. The smart card 200 card engine 220 can signal the screen 115 to display the assigned value 240, as shown. For instance, if the assigned value 240 represents the number of prepaid minutes remaining, displaying such information can inform the user that the prepaid minutes will soon be depleted and that more minutes should be purchased. Preferably, the communications device 100 can communicate with the seller of prepaid minutes and transmit payment authorization, and the assigned value 240 can be updated dynamically.

The card engine 220 can also signal the screen 115 to display regional information stored in the data store 230, as shown At the user request via the input structure 110 and/or 120, the card engine 220 can signal the screen 115 to display one or more of regional telephone numbers, regional addresses, regional advertisements, regional historic information, regional custom information, regional directions, and regional tourist information. For example, at a user request, the card engine 220 can signal the screen 115 to display regional telephone numbers, such as restaurant numbers within the region.

Further, it should be noted that the card engine 220 can signal the screen 115 to display the contents of the data store 230 without receiving any user input. For instance, the card engine 220 can signal the screen 115 to display regional custom information, such as a reminder to pray at specific times in Islamic regions. Further, the card engine 220 can also signal the screen 225 to display regional advertisements. The regional advertisements can be displayed continuously as a banner on the perimeter of the screen (as shown in FIG. 2B) or as a silhouette in the background. Also, the regional advertisements can be displayed intermittently during the use of the communications device 100. Notably, as the content of the data store 230 can be updated dynamically, the advertisements displayed can provide information pertaining to current events.

In one embodiment, the card engine 220 can be configured to translate regional language to the native language of the user. A language translation function 260 can be communicably linked to the card engine 220 via bus 235 and can provide logic rules for translating text in one language to text in another language. The language translation function can store multiple sets of logic rules for translating multiple languages. Further, it should be noted that the logic rules for translating text can be updated dynamically using the communications device to send and receive update transmissions to reflect trends and changes in language use, dictation, and grammar in an evolving language.

In such an embodiment, the user can input text in the regional language and select an option of translating the text to the native language of the user. The card engine 220 can receive the text from the communications device 100 and access the logic rules to translate the text. The card engine 220 can signal the screen 115 to display the text in the native language of the user, as shown in FIG. 2B with the example of translating “Hola” to “Hello”. Such functionality can be helpful in reading text that is easy to enter, such as menu descriptions, road signs, and the like. The card engine 220 can similarly be configured to translate the native language of the user into the regional language. Such functionality can be helpful in learning the regional language and communicating simple phrases to the locals.

In another embodiment, the card engine 220 can be configured to convert the regional currency values into the native currency values of a user. A currency conversion function 255 can be communicatively linked to the card engine 220 via bus 235 and can store one or more algorithms for converting a value in a regional currency to a value in another currency. The currency conversion function 255 can include multiple algorithms for converting a variety of currencies. Further, it should be noted that because the content of the data store 230, the programming of the card engine 220, and the currency conversion function 255 can be updated dynamically using the communications device to send and receive update transmissions, the currency conversion can be updated to reflect the daily fluctuation in currency values. Such functionality can be helpful in determining the value and costs of a purchase using a regional currency.

In operation, the user can input currency values in the regional currency and select an option of converting the values to the user's native currency values. The card engine 220 can receive the regional values from the communications device 100 and access the currency conversion function 255 for the appropriate updated algorithm. In accordance with the algorithms provided, the card engine 220 can convert the values and signal the screen 115 to display the values in the native currency of the user, as shown in FIG. 2B in the example of converting “1 Euro” to “1.12 USD”. The card engine 220 can similarly be configured to convert native user currency values into the regional currency values. Such functionality can be helpful in estimating the relative regional currency values without relying on constant conversions of exact amounts.

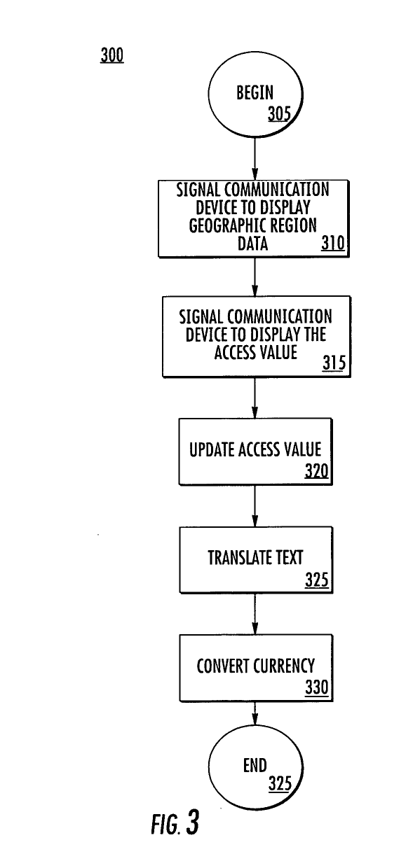

In one embodiment, the invention can include a device with machine readable storage having disposed thereon a currency converter and a text translator. The machine readable storage can also include a computer program having a routine set of instructions for limiting access to a wireless network based upon an access value pre-stored with the machine readable storage. One arrangement of the functions carried out by the machine readable storage is depicted in the flow chart of FIG. 3. It should be appreciated that functions can be removed and/or added to those depicted in FIG. 3. It should further be appreciated that the order of functions is not limited to the arrangement shown and can include variations of the order shown.

The steps of machine readable storage functions 300 can begin at step 305. At step 310 the machine readable storage can provide instructions for sending signals to the communications device to display geographic region data. Once the communications device receives the signals, the geographic region data can be displayed to the user of the device. The instructions for sending signals to the communications device can include a variety of content to be displayed. The content can include regional telephone numbers, regional addresses, regional advertisements, regional historic information, regional custom information, regional directions, and regional tourist information.

At step 315, the machine readable storage can provide instructions for sending signals to the communications device to display the access value. Additionally, it should be noted that signals can be sent to the communications device in real time usage of the communications device to reflect a diminishing accesses value. For instance, while a user of the communications device accesses a wireless network, the decreasing access value can be display to inform the user of dwindling access rights.

The access value can limit access to a wireless network and can be stored in the machine readable storage. The access value can correspond to pre-paid minutes for use to access a wireless network. The access value can also correspond to a monetary value used to determine and limit the amount of access that is available. For instance, the access value can represent a monetary value of 100 units. The 100 units can be used to limit the user's access to high speed wireless network connections to just a few minutes. Alternatively, the 100 units can be used to limit the user's access to slow speed wireless network connections to a few hours. Thus, depending upon the type of connection access, the access value can vary in the time and amount for which access is limited.

At step 320, the machine readable storage can provide instructions for updating the access value. As discussed above, the access value can decrease over time during network access. The amount and/or rate of decrease can be determined with the instructions provided by the machine readable storage. Alternatively, the machine readable storage can provide instructions for increasing the access value. For instance, during wireless access, the network can send signals indicating that the user have paid for an increased access value. The machine readable storage can interpret the network signals and update the access value accordingly. In another arrangement, the user can input payment information with the communications device and the machine readable storage can interpret the input and provide instructions for updating the access value accordingly.

At step 325, the text converter of the machine readable storage can provide instructions for translating language. The text convert can be configured with translation logic to enable translations to and from multiple to languages and the user's native language. In operation, text can be received from the communications device and the text convert can convert the text to anther language for display on the communications device.

At step 330, the currency converter of the machine readable storage can provide instructions for converting currencies. The currency converter can be configured with conversion algorithms to enable conversions to and from multiple currencies to the native currency of the user. Additionally, it should be noted the currency converter can be updated to reflect the daily fluctuations in exchange rates. At step 335, the machine readable storage can stop providing instructions and/or can repeat any previous instructions in any particular order.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: conversion to another language, code or notation; and reproduction in a different material form.

Although the present invention has been described in conjunction with the embodiments disclosed herein, it should be understood that the foregoing description is intended to illustrate and not limit the scope of the invention as defined by the claims.

In a telecommunications network, a switch is a device that channels incoming data from any of multiple input ports to the specific output port that will take the data toward its intended destination.

What is claimed is:

1. A communications device, comprising:
a transceiver for sending and receiving wireless signals;
a screen for displaying at least one of text and graphics;
at least one input structure for inputting information;
a removable smart card having at least one card engine and at least one data store, said data store storing data related to at least one geographic area and an assigned values; and
wherein said card engine determines operability of said communications device based on said assigned values.

2. The communications device according to claim 1, wherein said data related to at least one geographic region includes at least one of regional telephone numbers, regional addresses, regional advertisements, regional historic information, regional custom information, regional directions, and regional tourist information.

3. The communications device according to claim 2, wherein said card engine is configured to signal said screen to display at least one of said data related to at least one geographic region and said assigned value.

4. The communications device according to claim 1, wherein said card engine is configured to translate regional language into the native language of a user.

5. The communications device according to claim 1, wherein said card engine is configured to translate the native language of a user into the regional language.

6. The communications device according to claim 1, wherein said card engine is configured to convert regional currency values into the native currency values of a user.

7. The communications device according to claim 1, wherein said card engine is configured to convert the native currency values of a user into the regional currency values.

8. The communications device according to claim 1, wherein said card engine is configured to update said assigned value according to signals received by said transceiver.

9. A smart card, comprising:
at least one card engine, said card engine determining operability of said smart card based on at least one assigned value; and
at least one data store, said data store storing geographic region data and an assigned value.

10. The smart card according to claim 9, wherein said geographic region data includes at least one of regional telephone numbers, regional addresses, regional advertisements, regional historic information, regional custom information, regional directions, and regional tourist information.

11. The smart card according to claim 10, wherein said card engine is configured to signal said screen to display said geographic region data.

12. The smart card according to claim 9, wherein said card engine is configured to translate regional language into the native language of a user.

13. The smart card according to claim 9, wherein said card engine is configured to translate the native language of a user into the regional language.

14. The smart card according to claim 9, wherein said card engine is configured to convert regional currency values into the native currency values of a user.

15. The smart card according to claim 9, wherein said card engine is configured to convert the native currency values of a user into the regional currency values.

16. The smart card according to claim 9, wherein said card engine is configured to update said at least one assigned value according to received signals.

17. A travel assistance device, comprising:
a machine readable storage having disposed thereon a currency converter and a text translator, said machine readable storage further comprising a computer program comprising a routine set of instructions for limiting access to a wireless network based upon an access value pre-stored with the machine readable storage.

18. A travel assistance device according to claim 17, wherein said machine readable storage has a plurality of code sections executable by a machine for causing the machine to perform the step of signaling said device to display at least one of data related to at least one geographic region and said access value.

19. A travel assistance device according to claim 17, wherein said machine readable storage has a plurality of code sections executable by a machine for causing the machine to perform the steps of:
translating regional language into the native language of a user; and
translating the native language of a user into the regional language.

20. A travel assistance device according to claim 17, wherein said machine readable storage has a plurality of code sections executable by a machine for causing the machine to perform the steps of:
converting regional currency values into the native currency values of a user; and
converting the native currency values of a user into the regional currency values.

21. A travel assistance device according to claim 17, wherein said machine readable storage has a plurality of code sections executable by a machine for causing the machine to perform the step of updating said access value according to signals received by said device.
